(19) United States
(12) Patent Application Publication
(10) Pub. No.: US 2012/0077026 A1
(43) Pub. Date: Mar. 29, 2012

(54) SURFACE PROTECTIVE SHEET

(75) Inventors: Takeshi IGARASHI, Osaka (JP); Toshitaka SUZUKI, Osaka (JP); Mitsushi YAMAMOTO, Osaka (JP)

(73) Assignee: NITTO DENKO CORPORATION, Osaka (JP)

(21) Appl. No.: 13/238,856

(22) Filed: Sep. 21, 2011

(30) Foreign Application Priority Data
Sep. 27, 2010 (JP) 2010-215989

(51) Int. Cl. B32B 7/12; B32B 37/14; B05D 5/10

(52) U.S. Cl. 428/343; 427/208.4; 156/60

(57) ABSTRACT

A surface protective sheet 1 endowed with both a higher re-peelability and higher non-staining properties is provided. The surface protective sheet 1 has a supporting substrate 10 and a pressure-sensitive adhesive layer 20 provided on a front side of the supporting substrate 10. At least a portion of the supporting substrate 10, including the front side 10a, is made of a resin material that is composed primarily of a polyolefin and includes A: at least one of a fatty amide and a fatty acid metal salt, and B: an antioxidant. The content C_{A} of the component A, based on the weight of the resin material, is from 50 ppm to 500 ppm.

### CROSS-REFERENCE

This application claims priority to Japanese Patent Application No. 2010-215989 filed on Sep. 27, 2010, the entire contents of which are incorporated herein by reference.

### BACKGROUND OF THE INVENTION

1. Field of the Invention

The present invention relates to a sheet for protecting the surface of an adherend from damage and dirt.

2. Description of the Related Art

The bonding of a protective sheet to the surface of metal panels, coated steel panels, plastic panels and the like in order to protect the surface of such materials from damage and dirt when the material is worked or transported is known in the art. Surface protective sheets used for this purpose generally have a pressure-sensitive adhesive (PSA) layer on one side of a sheet-shaped substrate made of resin (supporting substrate), and are constructed so as to enable the purpose of protection to be achieved by bonding of the sheet to an adherend (an object to be protected) via the PSA layer. Surface protective sheets have been described in the prior-art, including Japanese Patent Application Laid-open Nos. 2000-136367, 2003-49132, 2002-285116 and H11-152452.

### SUMMARY OF THE INVENTION

Generally, a surface protective sheet is applied to an adherend for a limited period of time, including the time during which protection of the adherend is needed (e.g., the period in which working or transporting is carried out). After the protective role has ended, the protective sheet is removed (re-peeled) from the adherend. Surface protective sheets used in this manner are required both to exhibit a suitable initial adhesive strength to the adherend and also to have the quality of being re-peelable without leaving behind on the adherend surface components from the protective sheet (in other words, without staining the adherend surface with components from the protective sheet) once the protective role has ended (non-staining properties). Moreover, for the task of bonding the sheet to the adherend and the task of re-peeling the sheet from the adherend to be handily carried out, it is preferable that the adhesive strength, both the initial adhesive strength and during re-peeling, not be too strong.

In surface protective sheets which use a resin film as the supporting substrate, even if the initial adhesive strength is designed so as to fall in the suitable range just described, re-peelability is sometimes lost due to a large rise in the adhesive strength during the period of protection. One way to adjust the adhesive strength of the PSA layer is to include a fatty amide in the PSA layer (see, for example, paragraph [0019] of Japanese Patent Application Laid-open No. 2000-136367). However, when the amount of fatty amide included in the PSA layer increases, the adherend has a tendency to stain. Accordingly, it has been difficult to achieve in this way a surface protective sheet endowed with both a high re-peelability and high non-staining properties.

It is therefore an object of the present invention to provide a surface protective sheet composed of a supporting substrate and a PSA layer on a resin surface of the supporting substrate, which sheet achieves both a higher re-peelability and higher non-staining properties.

The inventors have focused on the antioxidants which may be included in the resin material making up the supporting substrate as the cause for the excessive rise in the adhesive strength. Moreover, the inventors have discovered that even a surface protecting film having a PSA layer provided on the surface of a resin material of a composition containing such an antioxidant, by including a suitable amount of specific ingredients in the resin material, is able to effectively suppress a rise in the adhesive strength while maintaining non-staining properties.

Accordingly, in a first aspect, the invention provides a surface protective sheet which has a supporting substrate, and a PSA layer provided on a front side of the supporting substrate. At least the front side portion of the supporting substrate is made of a resin material composed primarily of a polyolefin. The resin material includes A: at least one of a fatty amide and a fatty acid metal salt, and B: an antioxidant. The content C_{A} by weight of the component A in the resin material is from 50 ppm to 500 ppm. By thus including a suitable amount of the component A in the resin material making up at least the portion of the supporting substrate which comes into contact with the PSA layer, it is possible to suppress the increase in adhesive strength that may arise due to the component B, and to thereby achieve excellent non-staining properties with respect to the adherend.

In a preferred embodiment of the art disclosed herein, the content C_{B} by weight of the component B in the resin material is from 200 ppm to 2,000 ppm. In the supporting substrate obtained using a resin material of such a composition and in the surface protective sheet having such a supporting substrate, the resin material has a high thermal stability, thus giving the supporting substrate a good processability.

In this resin material, the ratio C_{A}/C_{B} of the content C_{A} of the component A to the content C_{B} of the component B is preferably from 0.05 to 0.40. A surface protective sheet having a PSA layer on a surface (front side of supporting substrate) composed of a resin material of such a composition is able to achieve both a higher re-peelability and higher non-staining properties.

It is not necessary for the PSA layer in the surface protective sheet disclosed herein to include component A. In one preferred embodiment, the PSA layer contains substantially no component A. The surface protective sheet of this embodiment is capable of having even better non-staining properties. Alternatively, the PSA layer may contain component A. In this case, it is preferable to set the weight Cₐ of the component A included per unit weight of the PSA layer so as to be smaller than the weight C_{A} of the component A included per unit weight of the resin material (i.e., Cₐ<C_{A}). With a surface protective sheet of such a composition, along with good non-staining properties, a better re-peelability can also be achieved.

The PSA layer in the surface protective sheet disclosed herein may or may not include component B. If the PSA layer includes the component B, it is preferable to set the weight C_{b} of the component B included per unit weight of the PSA layer so as to be smaller than the weight C_{B} of the component B included per unit weight of the resin material (i.e., C_{b}<C_{B}). The component B included in the resin material and the component B included in the PSA layer may be the same or may be different.

The PSA making up the PSA layer is preferably a non-crosslinking PSA. For example, preferred use can be made of non-crosslinking PSAs in which the base polymer is an isobutylene polymer.

Here, “PSA layer composed of a non-crosslinking PSA” refers to a PSA layer which, at the time of PSA layer formation, is not deliberately treated (i.e., subjected to crosslinking treatment, such as by including a crosslinking agent) so as to form chemical bonds between the polymers making up the PSA. Because strain substantially does not accumulate in such PSA layers (even when strain temporarily arises, it can be easily dispelled), the PSA layers have properties that are highly suitable as PSA layers for surface protective sheets; for example when the sheet is affixed to an adherend, such PSA layers do not readily leave marks on the adherend.

In a second aspect, this invention provides a method of manufacturing a surface protective sheet. The method includes the step of providing a supporting substrate. At least a front side portion of the supporting substrate is made of a resin material composed primarily of a polyolefin. The resin material includes A: at least one of a fatty amide and a fatty acid metal salt, and B: an antioxidant in respective contents (weight basis) C_{A} and C_{B}. The content C_{A} of the component A is from 50 ppm to 500 ppm. The content C_{B} of the component B is from 200 ppm to 2,000 ppm. The manufacturing method also includes the step of forming a PSA layer on the front side of the supporting substrate. In this PSA layer-forming step, it is preferable to form the PSA layer on the front side of the supporting substrate by directly applying a PSA composition to the front side of the supporting substrate or by laminating and transferring a PSA layer held on a peelable surface to the front side of the supporting substrate. This manufacturing method is preferred as the method of manufacturing any of the surface protective sheets disclosed herein.

The invention additionally provides another method of manufacturing a surface protective sheet which has a supporting substrate and a PSA layer on a front side of the supporting substrate, wherein at least the front side portion of the supporting substrate is made of a resin material composed primarily of a polyolefin and including above components A and B. This manufacturing method includes selecting the content C_{B} of the component B in the resin material. The manufacturing method also includes selecting the content C_{A} of the component A in the resin material in accordance with the selected C_{B}, such as to satisfy one or both of the conditions 50 ppm≦C_{A}≦500 ppm and 0.05≦C_{A}/C_{B}≦0.40. The manufacturing method further includes forming (typically, forming by extrusion) a sheet-shaped supporting substrate having a front side portion composed of a resin material which satisfies these selected C_{A} and C_{B}. In addition, the manufacturing method may also include forming a PSA layer on the front side of the supporting substrate. With such a method, it is possible to manufacture a surface protective sheet which has both a higher re-peelability and higher non-staining properties.

### BRIEF DESCRIPTION OF THE DRAWINGS

FIG. 1 is a schematic cross-sectional view of a configuration example of the surface protective sheet of the invention.

### DETAILED DESCRIPTION OF THE INVENTION

Preferred embodiments of the present invention are described below. Technical matters necessary to practice the invention, other than those specifically referred to in the specification, may be understood as design matters for a person skilled in the art that are based on the related art in the pertinent field. The present invention may be practiced based on the contents disclosed herein and common general technical knowledge in the pertinent field.

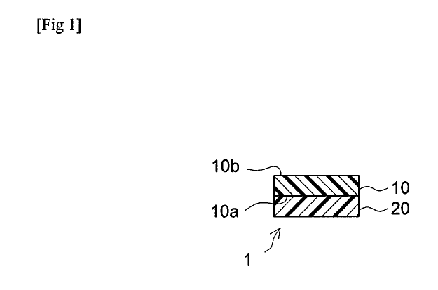

The surface protective sheet disclosed herein is composed of a PSA layer provided on a sheet-shaped supporting substrate. For example, as shown schematically in FIG. 1, the surface protective sheet 1 is composed of a supporting substrate 10 on one side (front side) 10a of which is provided a PSA layer 20, and is used by attaching the PSA layer 20 to an adherend (an object to be protected). The surface protective sheet 1 prior to use (i.e., prior to attachment to the adherend) may be in a form where the surface (bonding face) of the PSA layer 20 is protected with a release liner (not shown) having a release face on at least the PSA layer side thereof. Alternatively, it may be in a form where the other side (back side) 10b of the supporting substrate 10 is a release face and, by winding the protective sheet 1 into the form of a roll, the PSA layer 20 comes into direct contact with the back side 10b so that the surface thereof is protected. The supporting substrate 10 has a structure which may be composed of a single layer or may be composed of a plurality of layers that include at least two layers of differing composition. FIG. 1 illustrates an example of a single-layer supporting substrate 10.

In the supporting substrate of the art disclosed herein, at least a front side (the surface on the side where the PSA layer is provided) portion is made of a resin material which is composed primarily of (i.e., 50 wt % or more of which is) a polyolefin. Of the resin ingredients included in the resin material, the amount of polyolefin (when two or more polyolefins are included, the combined amount thereof) is typically 50 wt % or more. The amount of polyolefin may be 70 wt % or more, 85 wt % or more, 95 wt % or more, or substantially 100 wt %. Preferred examples of the polyolefin include polyethylene (PE) and polypropylene (PP). A resin material containing either or both of these is desirable. In a preferred embodiment, polypropylene accounts for at least 75 wt % (or even substantially 100 wt %) of the resin ingredients included in the resin material. In cases where other resin ingredients in addition to the above resin ingredient are included, the other resin ingredients may be polyolefins other than polypropylene, such as polyethylene.

The polypropylene may be any of various polymers containing propylene as a component therein (propylene polymers). As used herein, the concept of a “propylene polymer” includes polypropylenes such as the following.

Propylene homopolymers (i.e., homopolypropylene, also denoted below as “PP-h”), such as isotactic polypropylene, syndiotactic polypropylene and atactic polypropylene.

Random copolymers (random polypropylenes, also denoted below as “PP-r”) of propylene with another α-olefin (typically, one, two or more selected from among ethylene and α-olefins with 4 to 10 carbon atoms). Random polypropylenes in which propylene is the primary monomer (primary constituent monomer; i.e., a component accounting for at least 50 wt % of the overall monomer), such as PP-r obtained by random copolymerizing 96 mol % to 99.9 mol % of propylene with 0.1 mol % to 4 mol % of another α-olefin (typically ethylene and/or butene), are preferred.

Block copolymers (block polypropylenes, also denoted below as “PP-b”) obtained by block copolymerizing propylene with another α-olefin (typically one, two or more selected from among ethylene and α-olefins with 4 to 10 carbon atoms). Block polypropylenes in which propylene is the primary monomer are preferred. Such a block copolymer typically includes also, as a by-product, a rubber component composed of propylene and at least one other α-olefin. Preferred examples of such PP-b include PP-b which contains a polymer obtained by block copolymerizing 90 mol % to 99.9 mol % of propylene with 0.1 mol % to 10 mol % of another α-olefin (preferably ethylene and/or butene), and a rubber component composed of propylene and at least one other α-olefin.

Reactor blend type thermoplastic olefin resins (TPO) and thermoplastic elastomers (TPE) obtained by copolymerizing a large amount of rubber components in the above types of propylene polymers, or dry-blend type TPOs and TPEs obtained by mechanically dispersing such rubber components.

Copolymers of monomers having another functional group in addition to a polymerizable functional group (functional group-bearing monomers) and propylene, and copolymers obtained by copolymerizing such functional group-bearing monomers with a propylene polymer.

The resin material may include one, two or more such polypropylenes. When two or more polypropylenes are included, the polypropylenes may be used as a blend or may be used separately (e.g., as the constituent materials in mutually differing layers in a supporting substrate having a multilayer construction). The relative proportions (blending ratio) in which these polypropylenes are used are not subject to any particular limitation.

The above polyethylene may be various polymers (ethylene-based polymers) containing ethylene as an ingredient. The ethylene-based polymer may be a homopolymer of ethylene or may be a polymer obtained by the copolymerization of ethylene as the primary monomer with another α-olefin (random copolymerization, block copolymerization or the like). Preferred examples of such α-olefins include α-olefins with 3 to 10 carbon atoms such as propylene, 1-butene (may be branched 1-butene), 1-hexene, 4-methyl-l-pentene and 1-octene. Alternatively, the polyethylene resin may be a copolymer of a monomer having both a polymerizable functional group and also another functional group (functional group-containing monomer) with ethylene, or one obtained by copolymerizing such a functional group-containing monomer with an ethylene-based polymer. Illustrative examples of copolymers of ethylene and functional group-containing monomers include ethylene-vinyl acetate copolymers (EVA), ethylene-acrylic acid copolymers (EAA), ethylene-methacrylic acid copolymers (EMAA), ethylene-methyl acrylate copolymers (EMA), ethylene-ethyl acrylate copolymers (EEA), ethylene-methyl methacrylate copolymers (EMMA) and ethylene-(meth)acrylic acid (i.e., acrylic acid and/or methacrylic acid) copolymers that have been crosslinked with metallic ions.

The polyethylene density, which is not subject to any particular limitation, may be, for example, from about 0.9 g/cm³ to about 0.94 g/cm³ (typically, from 0.91 g/cm³ to 0.93 g/cm³). Preferred polyethylenes include low-density polyethylene (LDPE) and linear low-density polyethylene (LLDPE). The type of LLDPE is exemplified by those obtained using one or more copolymerizing ingredients selected from among branched 1-butene, 1-hexene, 4-methylpentene and 1-octene, and may be selected as appropriate and preferred. Such a polyethylene may be used singly or may be used as a combination of two or more types in any proportions.

In one embodiment of the surface protective sheet disclosed herein, the resin material (i.e., the resin material which makes up at least the front side portion of the substrate) has a melt mass flow rate (MFR) of from 0.5 g/10 min to 80 g/10 min. As used herein, “MFR” refers to the value measured in accordance with Method A of JIS K7210 at 230° C. and under a load of 21.18 N. It is preferable for this resin material to have a good extrudability.

This resin material may be one which includes another resin component, either in addition to or in place of polypropylene and/or polyethylene. Such a resin component is exemplified by polyolefins composed primarily of a polymer of an α-olefin with four or more carbon atoms (i.e., an olefin polymer composed primarily of such an α-olefin).

In the art disclosed herein, the resin material includes an antioxidant as the component B. Use may be made of various known types of antioxidants, such as phenolic antioxidants, phosphorus-containing (phosphite-based) antioxidants, sulfur-containing antioxidants and amine-based antioxidants. Illustrative examples of phenolic antioxidants include monophenol-type antioxidants such as 2,6-di-t-butyl-4-methylphenol and 2,6-di-tert-butyl-4-ethylphenol; bisphenol-type antioxidants such as 2,2′-methylenebis(4-methyl-6-t-butylphenol), 2,2′-methylenebis(4-ethyl-6-t-butylphenol), 4,4′-butylidenebis(3-methyl-6-t-butylphenol) and 4,4′-thiobis(3-methyl-6-t-butylphenol); and polymeric phenol-type antioxidants such as 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane and 1,1,3-tris(2-methyl-4-hydroxy-5-t-butylphenyl)butane. Illustrative examples of phosphorus-containing antioxidants include tris(2,4-di-t-butylphenyl)phosphite, tris(nonylphenyl)phosphite, triphenyl phosphite and distearylpentaerythritol diphosphite. Illustrative examples of sulfur-containing antioxidants include dilauryl 3,3′-thiodipropionate, dimyristyl 3,3′-thiodipropionate, distearyl 3,3′-thiodipropionate and pentaerythritol tetralauryl thiopropionate. Illustrative examples of amine-based antioxidants include phenyl α-naphthylamine and diphenylamine. These antioxidants may be used singly, or as suitable combinations of two or more in any ratio by weight.

The component B content C_{B} (weight basis; when two or more antioxidants are used, the combined content thereof) in the resin material may be suitably set so as to obtain the desired anti-oxidizing activity. Generally, it is preferable for C_{B} to be 2,000 ppm or less (e.g., 1,500 ppm or less). Also, it is preferable for C_{B} to be 200 ppm or more (e.g., 500 ppm or more). If C_{B} is too small, the thermal stability of the resin material tends to become inadequate, as a result of which the processability (typically, the processability in extrusion) of the supporting substrate may have a tendency to decline. If C_{B} is too high, the re-peelability (e.g., the ability to suppress an excessive rise in adhesive strength) of the surface protective sheet tends to decrease, but when an attempt is made to ensure a good re-peelability, the non-staining properties tend to diminish. In other words, it is difficult to achieve both a high re-peelability and high non-staining properties.

One or more types selected from among phenolic antioxidants, phosphorus-containing antioxidants and sulfur-containing antioxidants may be advantageously employed as the antioxidant in the art disclosed herein. Preferred examples include (i) resin materials containing one, two or more phenolic antioxidants (these may be resin materials containing substantially no antioxidants other than phenolic antioxidants), and (ii) resin materials containing one, two or more phenolic antioxidants and one, two or more phosphorus-containing antioxidants (these may be resin materials containing substantially no antioxidants other than phenolic antioxidants and phosphorus-containing antioxidants). In other words, a resin material which contains at least a phenolic antioxidant and which may or may not contain a phosphorus-containing antioxidant is preferred. In such resin materials, the content (weight basis) of the phenolic antioxidant is preferably 1,200 ppm or less (e.g., 1,000 ppm or less, or even 800 ppm or less), and is preferably 200 ppm or more (e.g., 500 ppm or more). In embodiments where the resin material contains a phosphorus-containing antioxidant, the content (weight basis) thereof is preferably 1,000 ppm or less (e.g., 800 ppm or less, 500 ppm or less, or even 300 ppm or less), and is preferably 50 ppm or more (e.g., 100 ppm or more). In above embodiment (ii), the ratio C_{B1}/C_{B2} of the content C_{B1} of the phenolic antioxidant to the content C_{B2} of the phosphorus-containing antioxidant may be set to from about 0.5 to about 20, and is generally set to from about 1 to about 10 (typically, from 1 to 7, such as from 1 to 5). Alternatively, C_{B1}/C_{B2} may be set to from about 3 to about 7 (e.g., 3 to 5). Such resin materials have an excellent thermal stability. The surface protective sheets obtained using such resin materials are capable of being endowed with an excellent re-peelability and excellent non-staining properties.

The resin material includes, as the component A, a fatty amide or a fatty acid metal salt or both. The content C_{A} of the component A (weight basis, when two or more types of the component A are included, the combined amount thereof) in the resin material is typically 50 ppm or more (e.g., 100 ppm or more) but 500 ppm or less. By setting C_{A} within the above range, it is possible to effectively suppress the effect of the antioxidant in the resin material on the re-peelability of the surface protective sheet (which effect is typically an excessive rise in the adhesive strength over time) and to achieve both a high re-peelability and high non-staining properties. If C_{A} is too small, the re-peelability tends to be inadequate. On the other hand, if C_{A} is too high, the non-staining properties tend to diminish.

Illustrative examples of the fatty acid metal salt which may be used include salts of a fatty acid such as stearic acid, lauric acid, ricinolic acid or octanoic acid with a metal such as calcium, magnesium, barium, lithium or zinc. These fatty acid metal salts may be used singly or as a suitable combination of two or more thereof in any weight ratio. Specific examples of fatty acid metal salts which may be advantageously used in the art disclosed herein include calcium stearate, magnesium stearate and zinc laurate.

Illustrative examples of the fatty acid amide include compounds of formulas (I), (II) or (III) below.

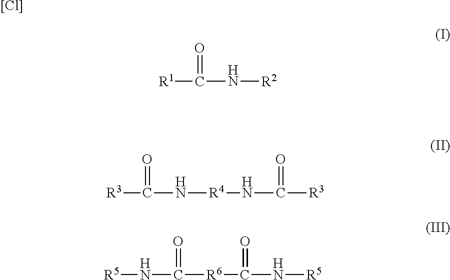

R¹ in above formula (I) is a monovalent saturated or unsaturated aliphatic hydrocarbon group having from 6 to 23 carbon atoms (this number of carbon atoms is indicated below as “C₆₋₂₃”). R² is a hydrogen atom or a C₆₋₂₃ monovalent saturated or unsaturated aliphatic hydrocarbon group. For example, compounds in which R² is a hydrogen atom are preferred.

R³ in formula (II) is a C₆₋₂₃ monovalent saturated or unsaturated aliphatic hydrocarbon group. R⁴ is a C₁₋₁₂ (e.g., C₁₋₆) divalent saturated or unsaturated aliphatic hydrocarbon group (e.g., saturated aliphatic hydrocarbon group), or a C₆₋₁₂ divalent aromatic hydrocarbon group. The two R³ moieties included in formula (II) may be the same or may be different. Typically, the two R³ moieties are the same group.

R⁵ in formula (III) is a C₆₋₂₃ monovalent saturated or unsaturated aliphatic hydrocarbon group. R⁶ is a C₁₋₁₂ (e.g., C₁₋₆) divalent saturated or unsaturated aliphatic hydrocarbon group (e.g., a saturated aliphatic hydrocarbon group) or a C₆₋₁₂ divalent aromatic hydrocarbon group. The two R⁵ moieties included in formula (III) may be the same or may be different. Typically, the two R⁵ moieties are the same group.

The saturated or unsaturated aliphatic hydrocarbon groups have a structure which may be linear, branched, cyclic, or a combination thereof.

Illustrative examples of the C₆₋₂₃ monovalent saturated aliphatic hydrocarbon groups include linear alkyl groups such as n-hexyl, n-octyl, n-decyl, n-dodecyl, n-tetradecyl, n-hexadecyl and n-octadecyl; branched alkyl groups such as ethylhexyl (e.g., 2-ethylhexyl), ethyloctyl and propylhexyl; and cyclic alkyl groups such as cyclohexyl, cycloheptyl, cyclopentenyl and cyclohexenyl.

Illustrative examples of C₆₋₂₃ monovalent unsaturated aliphatic hydrocarbon groups include 10-undecenyl, 9-hexadecenyl, cis-9-octadecyl (oleyl), 11-octadecenyl and cis,cis-9,12-octadecadienyl.

Illustrative examples of C₁₋₁₂ divalent saturated aliphatic hydrocarbon groups include methylene, ethylene, propylene, butylene, pentylene, hexylene, octylene, decylene, dodecylene, ethylhexylene (e.g., 2-ethylhexylene), ethyloctylene and propylhexylene.

Illustrative examples of C₁₋₁₂ divalent unsaturated aliphatic hydrocarbon groups include ethenylene, propenylene, butenylene, octenylene and dodecenylene.

Illustrative examples of C₆₋₁₂ divalent aromatic hydrocarbon groups include unsubstituted aryl groups such as phenyl and naphthyl; and alkyl-substituted phenyl groups such as tolyl, dimethylphenyl, ethylphenyl, butylphenyl, t-butylphenyl and dimethylnaphthyl.

Illustrative examples of fatty amides of formula (I) include laurylamide, oleamide, erucamide, ricinolamide, palmitamide, myristamide, behenamide, N-oleylstearamide, N-oleyloleamide, N-stearylstearamide, N-stearyloleamide, N-oleylpalmitamide and N-stearylerucamide.

Illustrative examples of fatty amides of formula (II) include N,N′-methylenebis(stearamide), N,N′-ethylenebis(laurylamide), N,N′-ethylenebis(stearamide), N,N′-ethylenebis(oleamide), N,N′-ethylenebis(behenamide), N,N′-ethylenebis(erucamide), N,N′-butylenebis(stearamide), N,N′-hexamethylenebis(stearamide), N,N′-hexamethylenebis(oleamide) and N,N′-xylylenebis(stearamide).

Illustrative examples of fatty amides of formula (III) include N,N′-dioleyladipamide, N,N′-distearyladipamide, N,N′-dioleylsebacamide, N,N′-distearylsebacamide, N,N′-distearylterephthalamide and N,N′-distearylisophthalamide.

Such fatty amides may be used singly or two or more may be suitably combined and used together in any weight ratio. In the art disclosed herein, examples of especially preferred fatty amides include erucamide, oleamide, stearamide and N,N′-ethylenebis(stearamide).

The art disclosed herein can be advantageously practiced in any of the following modes wherein the resin material includes as the component A: (a) a fatty amide alone (i.e., includes substantially no fatty acid metal salt), (b) a fatty acid metal salt alone (i.e., includes substantially no fatty amide), or (c) both a fatty amide and a fatty acid metal salt. In above mode (c), the ratio in the contents of the fatty amide and the fatty acid metal salt may be suitably selected without any particular limitation.

In a preferred embodiment, in above mode (a) or (c), the fatty amide content (in cases where two or more fatty amides are included, the combined amount thereof) C_{A2}, based on weight, is 300 ppm or less. Generally, it is suitable for C_{A2} to be 200 ppm or less, such as 150 ppm or less. C_{A2} may even be 100 ppm or less. Compared with fatty acid metal salts, fatty amides tend to exhibit a large re-peelability-enhancing effect for the content thereof. Therefore, by reducing the amount of fatty amide used within a range at which the desired re-peelability-enhancing effect can be obtained, it is possible to achieve both a high re-peelability and high non-staining properties. In mode (a) wherein the component A is a fatty amide alone, it is suitable for C_{A2} to be 70 ppm or more. For example, C_{A2} may be set to 80 ppm or more. At such a content, a particularly good re-peelability can be achieved. In mode (c), there is no particular lower limit for C_{A2}.

In another preferred embodiment, in above mode (b) or (c), the content of the fatty acid metal salt (in cases where two or more fatty acid metal salts are included, the combined amount thereof) C_{A1}, based on weight, is 100 ppm or more. For example, C_{A1} may be set to 200 ppm or more, or may even be set to 300 ppm or more.

As noted above, compared with fatty acid metal salts, fatty amides tend to exhibit a large re-peelability-enhancing effect for the content thereof. Also, compared with fatty amides, fatty acid metal salts tend not to stain the adherend even when included in a relatively large amount. Therefore, with above mode (c) which uses both a fatty acid metal salt and a fatty amide, a surface protective sheet which achieves both a higher re-peelability and higher non-staining properties can be achieved. In this mode (c), the ratio C_{A1}/C_{A2} of the fatty acid metal salt content C_{A1} to the fatty amide content C_{A2} may be set to, for example, from about 1 to about 20; it is generally appropriate to set this ratio to from about 2 to about 15 (e.g., from 5 to 10).

In above modes (a), (b) and (c), it is preferable for the value represented by the formula (C_{A1}/5)+C_{A2} to be from 50 ppm to 180 ppm (and more preferably from 80 ppm to 150 ppm). Such modes enable a surface protective sheet having both a higher re-peelability and higher non-staining properties to be achieved.

The types and contents of components A and B in the resin material may be determined by, for example, extracting the resin material with a suitable organic solvent and analyzing the resulting extract. In a case where the entire supporting substrate is composed of the above resin material (i.e., in the case of a single-layer supporting substrate), this supporting substrate in its entirety is used as the sample furnished for extraction. In a case where only the front side portion of the supporting substrate is composed of the above resin material, the sample may be collected from the front side portion of the supporting substrate (e.g., scraped away from the supporting substrate).

The supporting substrate in the art disclosed herein may be a single-layer supporting substrate which is formed in its entirety of the above resin material that forms the front side portion, or may be a supporting substrate with a multilayer structure having a layer formed of the above resin material on at least a front side (surface on the side where the PSA layer is provided) thereof. Alternatively, the supporting substrate may be one with a multilayer structure having a plurality of layers formed of the above resin material, which layers are provided on the front side and in other places (e.g., the back side, this being the surface on the side opposite from the front side). In a supporting substrate with a multilayer structure, a resin material composed primarily of a thermoplastic resin may be preferably used as the material making up portions other than the front side. Such a resin material may be one composed primarily of a polyolefin, or may be one composed primarily of a polymer other than a polyolefin. Examples of polymers other than polyolefins include polyvinyl alcohols and ethylene-vinyl acetate copolymers. Such polymers may be employed as secondary ingredients (ingredients used together with the polyolefin) in the resin material making up the front side portion of the supporting substrate.

The thickness of the supporting substrate is not subject to any particular limitation, and may be suitably selected according to the intended purpose. Generally, it is suitable to use a supporting substrate having a thickness of up to about 300 μm (e.g., from about 10 μm to about 200 μm). In a preferred embodiment of the surface protective sheet disclosed herein, the thickness of the supporting substrate is from 25 μm to 200 μm (and more preferably from 30 μm to 100 μm, such as from 30 μm to 60 μm). In cases where such a supporting substrate has a multilayer structure, the thickness of the layer of the substrate which adjoins the PSA layer may be set to, e.g., at least 3 μm (e.g., from 3 μm to 50 μm), and preferably at least 5 μm (e.g., from 5 μm to 30 μm).

Depending on the various properties required of the supporting substrate (for example, light-shielding properties, weather resistance, heat resistance, film-forming stability and adhesive properties) in addition to the component A and component B, the supporting substrate in the art disclosed herein may include, as needed, suitable ingredients for which inclusion in the substrate is allowed. For example, additives such as pigments (typically, inorganic pigments such as white pigments), fillers, light stabilizers (in a sense that is inclusive of radical scavengers and ultraviolet absorbers), slip agents, and anti-blocking agents may be suitably included. Examples of materials that may be suitably used as pigments or fillers include inorganic powders such as titanium oxide, zinc oxide and calcium carbonate. For example, advantageous use may be made of a highly weather-resistant type titanium oxide (typically, rutile-type titanium dioxide) coated on the particle surfaces with, for example, Si—Al₂O₃. The amount of inorganic pigment and filler may be suitably selected while taking into consideration the extent of the effects obtained by such inclusion and the resin sheet-forming process (e.g., T-die extrusion, blown-film extrusion). Generally, it is preferable to set the amount of inorganic pigment and filler (in cases where a plurality of types are included, the combined amount thereof) to from about 2 parts by weight to about 20 parts by weight (e.g., from 4 parts by weight to 20 parts by weight, and more preferably from 5 parts by weight to 15 parts by weight) per 100 parts by weight of the resin component. The amount of the respective ingredients (additives) may be set to about the same level as the normal amount in the field of resin sheets used as supporting substrates in surface protective sheets. In a supporting substrate having a multilayer structure, the type and concentration of the additives included in the respective layers may be the same or different.

The supporting substrate may be manufactured by suitably using a common film-forming method known to the art. Illustrative examples include a process in which a molding material formulated from the various ingredients which form the supporting substrate is melted, and the molding material in a molten state is extruded in the form of a film from a linear slit provided in a flat die (T-die extrusion), and a process in which the above molding material in a molten state is extruded in the form of a tube from a circular die, then inflated by blowing a gas such as air into the tube (blown-film extrusion or inflation molding). The use of a polyolefin film which has been extruded (formed into a film) by T-die extrusion as the supporting substrate in the art disclosed herein is preferred because of the desirable properties of such as a film, including the good thickness precision and ease of use.

Of the supporting substrate (typically a resin sheet) 10 shown in FIG. 1, the surface 10a on the side where the PSA layer 20 is provided may be subjected to surface treatment such as acid treatment, corona discharge treatment, ultraviolet irradiation treatment or plasma treatment. Alternatively, such surface treatment need not necessarily be carried out. If necessary, the back side 10b of the supporting substrate 10 on the side opposite from that where the PSA layer 20 is provided may be subjected to release treatment (e.g., treatment that involves applying a common silicone, long-chain alkyl, or fluorine-based release treatment agent in the form of a thin film having a thickness of typically from about 0.01 μm to about 1.0 μm, e.g., from about 0.01 μm to about 0.1 μm). By applying such a release treatment, the protective sheet 1 that has been wound in roll form can be easily and effectively unwound.

The PSA layer provided on the surface protective sheet disclosed herein is a PSA layer composed of a non-crosslinking PSA. Illustrative examples of the non-crosslinking PSA include PSAs in which the base polymer is an A-B-A type block copolymer rubber, an A-B-A type random copolymer, or a hydrogenated product (hydrogen addition product) thereof; and PSAs in which the base polymer is a butene polymer containing butene (inclusive of 1-butene, cis- or trans-2-butene, and 2-methylpropene(isobutylene)) as the chief monomer. Specific examples of such A-B-A type block copolymer rubbers or A-B-A type random copolymers or hydrogenated products thereof include styrene-butadiene-styrene block copolymer rubber (SBS), styrene-butadiene random copolymer (SBR), styrene-isoprene-styrene block copolymer rubber (SIS), styrene-vinyl isoprene-styrene block copolymer rubber (SVIS), styrene-ethylene-butylene-styrene block copolymer rubber (SEBS) which is a hydrogenated product of SBS, styrene-isobutylene-styrene block copolymer rubber (SIBS), styrene-ethylene-propylene-styrene block copolymer rubber (SEPS) which is a hydrogenated product of SIS, and hydrogenated styrene-butadiene copolymer (H-SBR) which is a hydrogenated product of SBR. Specific examples of the butene polymer include isobutylene polymers such as polyisobutylene and isobutylene-isoprene copolymers. Other examples of polymers that may serve as the base polymer of the non-crosslinking PSA include olefin polymers such as propylene-α-olefin copolymers and propylene-ethylene-α-olefin copolymers.

In a preferred embodiment, the PSA making up the PSA layer is a non-crosslinking PSA formed of a PSA composition in which the base polymer is an isobutylene-based polymer (i.e., a polyisobutylene-based PSA). Because such a polyisobutylene-based PSA has a high elastic modulus, it is ideal as the PSA for a surface protective sheet used in embodiments where the surface protective sheet is re-peeled following completion of the protective role (re-peelable PSA).

The above isobutylene polymer may be an isobutylene homopolymer (homopolyisobutylene) or a copolymer in which the main monomer is isobutylene (in other words, a copolymer in which isobutylene is copolymerized at a ratio exceeding 50 mol %). The copolymer may be, for example, a copolymer of isobutylene and n-butylene, a copolymer of isobutylene and isoprene (e.g., butyl rubbers such as regular butyl rubber, chlorinated butyl rubber, brominated butyl rubber and partially crosslinked butyl rubber), or a vulcanized form or modified form (e.g., one modified with functional groups such as hydroxyl groups, carboxyl groups, amino groups, or epoxy groups) thereof. From the standpoint of adhesive strength stability (e.g., the quality where the adhesive strength does not rise excessively over time or due to the thermal history), examples of isobutylene polymers preferred for use include homopolyisobutylene and isobutylene-n-butylene copolymers. Of these, homopolyisobutylene is preferred.

The PSA used in the surface protective sheet disclosed herein may contain, if necessary, suitable ingredients (additives) whose inclusion in such PSAs is permitted. Examples of such additives include softeners, tackifiers, peeling aids, pigments, fillers, antioxidants, and light stabilizers (including radical scavengers, ultraviolet absorbers or the like).

Preferred examples of tackifiers that may be used include alkyl phenol resins, terpene phenol resins, epoxy resins, coumarone indene resins, rosin resins, terpene resins, alkyd resins, and hydrogenates thereof. When a tackifier is used, the amount thereof may be set to, for example, from approximately 0.1 parts by weight to 50 parts by weight, per 100 parts by weight of the base polymer. Generally, it is preferable for the amount of tackifier included to be set to from 0.1 parts by weight to 5 parts by weight per 100 parts by weight of the base polymer. Alternatively, the PSA may have a composition which is substantially free of tackifier.

Examples of softeners include low-molecular-weight rubber materials, process oils (typically paraffinic oils), petroleum-based softeners and epoxy compounds. Examples of peeling aids include silicone-based peeling aids, paraffinic peeling aids, polyethylene wax and acrylic polymers. When a peeling aid is used, the amount thereof may be set to, for example, from about 0.01 parts by weight to about 5 parts by weight per 100 parts by weight of the base polymer. Alternatively, the PSA may have a composition which is substantially free of peeling aid. Examples of pigments or fillers include inorganic powders such as titanium oxide, zinc oxide, calcium oxide, magnesium oxide and silica.

Each of these additives may be used either singly or as a combination of two or more types thereof The amount of the respective additives may be set to, for example, the same level as the ordinary amount in the field of PSAs for surface protective sheets. The combined amount of the above tackifiers and additives is preferably set to 30 parts by weight or less (and more preferably 15 parts by weight or less) per 100 parts by weight of the base polymer.

In the art disclosed herein, there is no impediment to including one or both of above components A and B not only in the resin material making up the front side portion of the supporting substrate, but also in the PSA layer. However, it is preferable for the amount Cₐ of the component A included in the PSA layer per unit weight of the PSA layer to be smaller than the amount C_{A} of the component A included in the resin material per unit weight of the resin material. In other words, it is preferable for the concentration of the component A in the PSA layer to be lower than the concentration of the component A in the resin material. The component A included in the resin material and the component A included in the PSA layer may be the same or may be different. Likewise, it is preferable for the amount C_{b} of the component B included in the PSA layer per unit weight of the PSA layer to be lower than the amount C_{B} of the component B included in the resin material per unit weight of the resin material. The component B included in the resin material and the component B included in the PSA layer may be the same or may be different. The art disclosed herein can be advantageously practiced in a mode where the PSA layer includes substantially no component A, in a mode where the PSA layer includes substantially no component B, or in a mode where the PSA layer includes substantially no component A and substantially no component B.

The thickness of the PSA layer is not subject to any particular limitation, and may be suitably set according to the intended object. Generally, a thickness of up to 100 μm (e.g., from 1 μm to 100 μm) is appropriate, a thickness from about 1 μm to about 50 μm is preferred, and a thickness of from about 3 μm to about 20 μm is more preferred.

Formation of the PSA layer may be carried out in general accordance with known methods of forming PSA layers in adhesive sheets. For example, preferred use may be made of a direct process wherein a PSA composition in which a PSA layer-forming material containing the polymer ingredients and any additives to be optionally included is dissolved or dispersed in a suitable solvent is directly applied (typically coated) onto a supporting substrate and dried to form the PSA layer. Alternatively, use may be made of a transfer process wherein the above PSA composition is applied onto a surface having good peelability (e.g., the surface of a peeling liner, or the release-treated back face of the supporting substrate) and dried, thereby forming a PSA layer on the surface, following which the PSA layer is transferred to a supporting substrate. This PSA layer is typically formed continuously although, depending on the intended object and use thereof, it may be formed in a regular (e.g., dotted or striped) pattern or in a random pattern.

### EXAMPLES

Several experimental examples of the invention are described below, although these specific examples are not intended to limit the scope of the invention. In the description that follows, unless noted otherwise, all references to “parts” and “%” are based on the weight.

### [Production of Surface Protective Sheets]

Surface protective sheets having the construction shown in FIG. 1 were produced as follows.

Supporting substrates according to each of the respective examples were produced by compounding the various additives shown in Table 1 in the indicated amounts with 50 parts of polypropylene (available under the trade name “FY4” from Japan Polypropylene Corporation and 50 parts of polypropylene (available under the trade name “FX4E” from Japan Polypropylene Corporation), melt blending the resulting composition in an extruder, and forming the composition into a film having a total thickness of 40 μm by a T-die method. In each example, the processability was good. Tetrakis[methylene-3-(3′,5′-di-t-butyl-4′-hydroxyphenyl)propionate]methane (available under the trade name “Irganox 1010” from BASF) was used as a phenolic antioxidant. Tris(2,4-di-t-butylphenyl)phosphite (“Irgafos 168” from BASF) was used as a phosphorus-containing antioxidant. Calcium stearate was used as a fatty acid metal salt, and erucamide was used as a fatty amide. In addition to the additives shown in Table 1, 1,000 ppm of SiO₂ was included as an antiblocking agent in the supporting substrates of each example.

A PSA solution was prepared by dissolving 100 parts of the isobutylene polymer (a polyisobutylene produced by BASF under the trade name “Oppanol B-80”) as the base polymer in toluene. This PSA solution was directly coated onto the front side of the supporting substrate in the respective examples obtained as described above and dried, thereby forming a PSA layer having a thickness of 10 μm. Surface protective sheets according to Examples 1 to 8 were produced in this way.

The following evaluation tests were carried out on the surface protective sheets obtained in the respective examples.

### [Re-Peelability]

Test pieces were prepared by cutting the surface protective sheet in each example into 20 mm wide strips. The test pieces were bonded under pressure to a stainless steel SUS 430BA plate (No. 4 finish) as the adherend in a 23° C., 50% RH test environment. Bonding was carried out with a laminator at a linear pressure of 78.5 N/cm and a rate of 0.3 m/min. The test piece was then held for 48 hours, following which the peel strength (adhesive strength after elapsed time, N/20 mm) was measured in the same environment using a tensile testing machine at a peel rate of 10 m/min and a peel angle of 180°. Measurement was carried out three times. The arithmetic mean of the three results are shown in Table 1 as the measured value. Based on these peel strength values, the re-peelability of the surface protective sheet in each example was rated according to the following three criteria.

Good: Peel strength was at least 1 N/20 mm, but not more than 5 N/20 mm.

Fair: Peel strength was more than 5 N/20 mm, but not more than 7 N/20 mm.

NG: Peel strength was more than 7 N/20 mm.

Aside from setting the length of time from pressure-bonding of the test piece to the adherend until peel strength measurement is carried out to 30 minutes, the initial adhesive strength of the surface protective sheet in each example was measured in the same way as described above. When this was done, the initial adhesive strength in each case was at least 2 N/20 mm, but not more than 3 N/20 mm.

### [Non-Staining Properties]

Test pieces were prepared by cutting the surface protective sheet in each example into 20 mm wide strips. The tests pieces were attached over a length of about 60 mm to a flat portion of the frame (adherend) of a Model LC-46XJ1-B liquid-crystal TV manufactured by Sharp Corporation. This was held in a 50° C. temperature environment for 7 days, then held for at least 30 minutes in a 23° C., 50% RH environment, following which the test piece was peeled by hand from the adherend in the same environment at a peel rate of about 10 m/min and a peel angle of 180°. The surface of the adherend after peeling was visually examined, and rated for the presence or absence of staining. The test was carried out using three test pieces for each example. The results, rated according to the following two criteria, are shown in Table 1.

Good: Staining was not observed in any of the three test pieces.

NG: Staining was observed in at least one of the test pieces.

TABLE 1

| | EX 1 | EX 2 | EX 3 | EX 4 | EX 5 | EX 6 | EX 7 | EX 8 |
|---|---|---|---|---|---|---|---|---|
| Fatty acid metal salt | 400 | 500 | — | — | — | — | — | 1,000 |
| C_{A1} (ppm) | | | | | | | | |
| Fatty amide C_{A2} | 50 | — | 100 | 100 | 20 | — | 600 | — |
| (ppm) | | | | | | | | |
| (Total) | (450) | (500) | (100) | (100) | (20) | (0) | (600) | (1,000) |
| C_{A} (ppm) | | | | | | | | |
| Phenolic antioxidant | 1,000 | 1,000 | 1,000 | 600 | 1,000 | 600 | 1,000 | 1,000 |
| C_{B1} (ppm) | | | | | | | | |
| Phosphorus- | 200 | 1,000 | 200 | — | 200 | — | — | 1,000 |
| containing | | | | | | | | |
| antioxidant C_{B2} | | | | | | | | |
| (ppm) | | | | | | | | |
| (Total) | (1,200) | (2,000) | (1,200) | (600) | (1,200) | (600) | (1,000) | (2,000) |
| C_{B} (ppm) | | | | | | | | |
| (C_{A1}/5) + C_{A2} (ppm) | 130 | 100 | 100 | 100 | 20 | — | 600 | 200 |
| C_{A}/C_{B} | 0.38 | 0.25 | 0.08 | 0.17 | 0.03 | 0.00 | 0.60 | 0.50 |
| Peel strength | 3.5 | 4.2 | 2.8 | 4.1 | 6.4 | 8.1 | 2.0 | 3.0 |
| (N/20 mm) | | | | | | | | |
| Re-peelability | good | good | good | good | fair | NG | good | good |
| Non-staining | good | good | good | good | good | good | NG | NG |
| properties | | | | | | | | |

As shown in Table 1, the surface protective sheets of Example 1 to 4 provided with a supporting substrate containing from 50 ppm to 500 ppm of the component A and from 200 ppm to 2,000 ppm of the component B were confirmed to exhibit an excellent performance for both re-peelability and non-staining properties. By contrast, in Examples 5 and 6, wherein the supporting substrates had either no component A or only a low component A content, the re-peelability was inadequate. In Examples 7 and 8, wherein the content of the component A was too high, the non-staining properties were diminished.

The embodiments thus disclosed in detail according to the present invention are to be considered in all respects as illustrative and not limiting. The scope of the invention is indicated by the appended claims rather than by the foregoing description, and all changes which come within the meaning and range of equivalency of the claims are intended to be embraced therein.

The surface protective sheet of this invention is well-adapted for use as a surface protective sheet which, when attached to an adherend (the object to be protected) such as sheet metal, coated sheet steel or a plastic panel, carries out the role of protecting the surface of the adherend from damage and dirt when the adherend is worked or transported, and which, after such a protective role is over, is re-peeled from the adherend.

What is claimed is:

1. A surface protective sheet comprising:
a supporting substrate; and
a pressure-sensitive adhesive layer provided on a front side of the supporting substrate,
wherein at least the front side portion of the supporting substrate is made of a resin material that is composed primarily of a polyolefin and includes:
A: at least one of a fatty amide and a fatty acid metal salt; and
B: an antioxidant,
in respective contents C_{A} and C_{B} by weight based on the resin material, the content C_{A} of the component A being from 50 ppm to 500 ppm.

2. The surface protective sheet according to claim 1, wherein the content C_{B} of the component B is from 200 ppm to 2,000 ppm.

3. The surface protective sheet according to claim 1, wherein the ratio C_{A}/C_{B} is from 0.05 to 0.40.

4. The surface protective sheet according to claim 1, wherein the pressure-sensitive adhesive layer satisfies at least one of the following conditions:
the layer includes no component A or includes the component A in a lower concentration than in the resin material; and
the layer includes no component B or includes the component B in a lower concentration than in the resin material.

5. The surface protective sheet according to claim 1, wherein the pressure-sensitive adhesive layer is composed of a non-crosslinking pressure-sensitive adhesive.

6. The surface protective sheet according to claim 2, wherein the ratio C_{A}/C_{B} is from 0.05 to 0.40.

7. The surface protective sheet according to claim 2, wherein the pressure-sensitive adhesive layer satisfies at least one of the following conditions:
the layer includes no component A or includes the component A in a lower concentration than in the resin material; and
the layer includes no component B or includes the component B in a lower concentration than in the resin material.

8. The surface protective sheet according to claim 2, wherein the pressure-sensitive adhesive layer is composed of a non-crosslinking pressure-sensitive adhesive.

9. The surface protective sheet according to claim 6, wherein the pressure-sensitive adhesive layer satisfies at least one of the following conditions:
the layer includes no component A or includes the component A in a lower concentration than in the resin material; and
the layer includes no component B or includes the component B in a lower concentration than in the resin material.

10. The surface protective sheet according to claim 6, wherein the pressure-sensitive adhesive layer is composed of a non-crosslinking pressure-sensitive adhesive.

11. The surface protective sheet according to claim 9, wherein the pressure-sensitive adhesive layer is composed of a non-crosslinking pressure-sensitive adhesive.

12. The surface protective sheet according to claim 7, wherein the pressure-sensitive adhesive layer is composed of a non-crosslinking pressure-sensitive adhesive.

13. The surface protective sheet according to claim 3, wherein the pressure-sensitive adhesive layer satisfies at least one of the following conditions:
the layer includes no component A or includes the component A in a lower concentration than in the resin material; and
the layer includes no component B or includes the component B in a lower concentration than in the resin material.

14. The surface protective sheet according to claim 3, wherein the pressure-sensitive adhesive layer is composed of a non-crosslinking pressure-sensitive adhesive.

15. The surface protective sheet according to claim 13, wherein the pressure-sensitive adhesive layer is composed of a non-crosslinking pressure-sensitive adhesive.

16. The surface protective sheet according to claim 4, wherein the pressure-sensitive adhesive layer is composed of a non-crosslinking pressure-sensitive adhesive.

17. A method of manufacturing a surface protective sheet, comprising the steps of:
providing a supporting substrate, at least a front side portion of the substrate being made of a resin material that is composed primarily of a polyolefin and includes A: at least one of a fatty amide and a fatty acid metal salt, and B: an antioxidant, in respective contents C_{A} and C_{B} by weight based on the resin material, the content C_{A} of the component A being from 50 ppm to 500 ppm and the content C_{B} of the component B being from 200 ppm to 2,000 ppm; and
forming a pressure-sensitive adhesive layer on the front side of the supporting substrate by directly applying a pressure-sensitive adhesive composition to the front side of the supporting substrate or by laminating and transferring a pressure-sensitive adhesive layer held on a peelable surface to the front side of the supporting substrate.

18. The method according to claim 17, wherein the ratio C_{A}/C_{B} is from 0.05 to 0.40.

19. The method according to claim 18, wherein the pressure-sensitive adhesive layer satisfies at least one of the following conditions:
the layer includes no component A or includes the component A in a lower concentration than in the resin material; and
the layer includes no component B or includes the component B in a lower concentration than in the resin material.

20. The method according to claim 19, wherein the pressure-sensitive adhesive layer is composed of a non-crosslinking pressure-sensitive adhesive.
